(19) United States
(12) Patent Application Publication
(10) Pub. No.: US 2017/0073473 A1
(43) Pub. Date: Mar. 16, 2017

(54) SILICONE HAVING A BIS(TRIALKYLSILYL) AMINOPROPYL GROUP AT ONE TERMINAL

(71) Applicant: SHIN-ETSU CHEMICAL CO., LTD., Tokyo (JP)

(72) Inventors: Shoji ICHINOHE, Annaka-shi (JP); Muneo KUDO, Annaka-shi (JP)

(73) Assignee: SHIN-ETSU CHEMICAL CO., LTD., Tokyo (JP)

(21) Appl. No.: 15/253,192

(22) Filed: Aug. 31, 2016

(30) Foreign Application Priority Data
Sep. 11, 2015 (JP) 2015-179923

(51) Int. Cl. C08G 77/26

(52) U.S. Cl. CPC C08G 77/26

(57) ABSTRACT

The present invention provides a silicone having a bis(trialkylsilyl)aminopropyl group at one terminal and represented by the following general formula [II]:

R′R₂SiO(R₂SiO)ₘR₂SiC₃H₆N(SiR₃)₂ [II]

wherein m is an integer of from 1 to 200, R′ is an alkyl group having 1 to 4 carbon atoms, and R is an alkyl group having 1 to 10 carbon atoms.

### CROSS REFERENCE

This application claims the benefits of Japanese Patent application No. 2015-179923 filed on Sep. 11, 2015, the contents of which are herein incorporated by reference.

### FIELD OF THE INVENTION

The present invention relates to a silicone having a bis (trialkylsilyl) aminopropyl group at one terminal and a method for preparing the same.

One-terminal functionalized silicone compounds having a functional group such as a carbinol, carboxy, epoxy, methacryl and phenol groups are commercially available mainly as resin modifiers. However, a silicone compound having an amino group at one terminal is not commercialized.

Bis(trimethylsilyl)allylamine is known. For instance, Japanese Patent Application Laid-Open No. Hei-10-218883, Patent Literature 1, describes a method for preparing this compound, where bis(trimethylsilyl)allylamine is addition reacted with hydrotriethoxysilane to prepare an aminosilane coupling agent, or bis(trimethylsilyl)allylamine is addition reacted with dimethylethoxysilane and, then, hydrolyzed to prepare 1,3-bis(3-aminopropyl)-1,1,3,3-tetramethyldisiloxane.

### PRIOR LITERATURE

### Patent Literature

[Patent Literature 1] Japanese Patent Application Laid-Open No. Hei-10-218883

### DISCLOSURE OF THE INVENTION

### Problems to be Solved by the Invention

Patent Literature 1 describes a reaction of bis(trimethylsilyl)allylamine with an alkoxysilane, but does not describe any reaction of bis(trimethylsilyl)allylamine with a hydrogenpolysiloxane.

One of the purposes of the present invention is to provide a bis(trialkylsilyl)allylamine which reacts well with a hydrogenpolysiloxane with less side reactions which are not an addition reaction.

### Means to Solve the Problems

For the aforesaid purpose, the present compound is obtained with a high purity and a high yield, the present inventors have made research and found that by a reaction of a polysiloxane having a hydrosilyl group at one terminal with bis(trialkylsilyl)allylamine.

Thus, the present invention provides a silicone having a bis(trialkylsilyl)aminopropyl group at one terminal and represented by the following general formula [II]:

R′R₂SiO(R₂SiO)ₘR₂SiC₃H₆N(SiR₃)₂ [II]

wherein m is an integer of from 1 to 200, R′ is an alkyl group having 1 to 4 carbon atoms, and R is an alkyl group having 1 to 10 carbon atoms.

### Effects of the Invention

All of the active hydrogen atoms of the amino group are replaced with trialkylsilyl groups in bis(trialkylsilyl)allylamine and, therefore, no side reaction occurs in addition to the addition reaction. Thus, a purity and a yield of the envisaged compound are very high. In contrast, when a monotrialkylsilylallylamine reacts with a polysiloxane having a hydrosilyl group at one terminal, a dehydrogenation reaction occurs between —NH and —SiH to thereby form an NSi bond and, therefore, a purity and a yield of the envisaged compound are lower.

### BRIEF EXPLANATION OF THE DRAWINGS

FIG. 1 shows a chart of ¹H-NMR spectra of the compound prepared in Example 1.

FIG. 2 shows a chart of GPC of the compound prepared in Example 2.

### BEST MODE OF THE INVENTION

The present invention will be described below in detail.

The present invention provides a silicone having a bis(trialkylsilyl)aminopropyl group at one terminal and represented by the following general formula [II]:

R′R₂SiO(R₂SiO)ₘR₂SiC₃H₆N(SiR₃)₂ [II]

In the formula [II], m is an integer of from 1 to 200, preferably 2 or more, more preferably 3 or more, preferably 150 or less, more preferably 80 or less. R′ is an alkyl group having 1 to 4 carbon atoms, such as a methyl group, an ethyl group, a propyl group, an isopropyl group, a butyl group and a t-butyl group. R is a branched or linear alkyl group having 1 to 10 carbon atoms, and preferably a methyl, ethyl, propyl, butyl or pentyl group.

The bis(trialkylsilyl)aminopropyl silicone represented by the aforesaid general formula [II] is obtained by an addition reaction of a polysiloxane having a hydrosilyl group at one terminal and represented by the following general formula [I] with a bis(tri C_{1 to 10} alkylsilyl)allylamine, preferably in the presence of a hydrosilylation catalyst, particularly a platinum catalyst.

R′R₂SiO(R₂SiO)ₘR₂SiH [I]

wherein m, R′ and R are as defined above.

The addition reaction may be carried out with or without a solvent, preferably with a solvent. Examples of the preferable solvent include aliphatic hydrocarbons such as hexane, methyl cyclohexane and ethylcyclohexane; aromatic hydrocarbons such as toluene and xylene; alcohols such as ethanol and isopropanol; esters such as ethyl acetate and butyl acetate; ethers such as dioxane, dibutyl ether and dimethoxyethane; ketones such as methylisobutylketone; and chlorine solvents such as chloroform. In particular, an aromatic hydrocarbon such as toluene is the most preferable. An amount of the solvent is not particularly limited and may properly be decided.

The hydrosilylation catalyst may be noble metal catalysts, preferably platinum catalysts derived from chloroplatinic acid. If chlorine ions of chloroplatinic acid remain in the catalyst, a reaction mixture is in an acidic condition, so that an N—Si bond in bis(trialkylsilyl)allylamine is hydrolyzed. The NH bond generated in the hydrolyzation causes an increased dehydrogenation reaction. Therefore, it is preferred to use a platinum catalyst neutralized with sodium bicarbonate so as to make a reaction mixture neutral. It is preferred to completely neutralize chlorine ions with sodium bicarbonate to thereby increase stability of the platinum catalyst. For instance, a complex of chloroplatinic acid neutralized with sodium bicarbonate and 1,1,3,3-tetramethyl-1,3-divinyldisiloxane is most preferable as a catalyst.

An amount of the catalyst may be such that the addition reaction is sufficiently promoted. For instance, when a complex of chloroplatinic acid neutralized with sodium bicarbonate and 1,1,3,3-tetramethyl-1,3-divinyldisiloxane is used, the amount, reduced as a platinum metal, is 5 to 80 ppm by weight, relative to weight of the siloxane having a hydrosilyl group at one terminal. If the amount of the catalyst is too small, the reaction speed is too slow and the addition reaction does not proceed well. Even if the amount of the catalyst is larger than the aforesaid one, the reactivity is not particularly improved and, therefore, this is uneconomical.

A temperature of the addition reaction is not particularly limited and may properly be decided. In particular, the reaction temperature is 20 to 150 degrees C., preferably 50 to 120 degrees C., further preferably 80 to 90 degrees C. All of the materials may be mixed and reacted in one step. More preferably, the polysiloxane having a hydrosilyl group at one terminal, a solvent such as toluene, and the hydrosilylation catalyst are put in a reactor and, then, an excessive amount of bis (tri C_{1 to 10} alkylsilyl) allylamine is added dropwise in the reactor to be reacted. The reaction time is, for instance, 1 to 12 hours, preferably from 3 hours to 8 hours.

An amount of bis (tri C_{1 to 10} alkylsilyl) allylamine to be reacted is preferably excessive in mole, relative to the siloxane having a hydrosilyl group at one terminal. For instance, the amount is preferably 1.01 to 3 moles, further preferably 1.05 moles or more, particularly 1.1 moles or more, and further preferably 2 moles or less, particularly 1.5 moles or less, per mole of the siloxane having a hydrosilyl group at one terminal.

After the end of adding the bis (tri C_{1 to 10} alkylsilyl) allylamine, the reaction is continued, for instance, at 80 to 90 degrees C. for 2 hours. Then, absence of unreacted one-terminal hydrosilyl group-containing siloxane is confirmed, for instance, by disappearance of a peak in gas chromatography (hereinafter sometimes abbreviated as “GC”). Then, the reaction solution is subjected to stripping to remove a solvent such as toluene and an excessive amount of bis (tri C_{1 to 10} alkylsilyl) allylamine at an internal temperature of 130 degrees C. to obtaine a silicone having a bis(trialkylsilyl)aminopropyl group at one terminal and represented by the aforesaid general formula [II] with a high purity.

### EXAMPLES

The present invention will be explained below in further detail with reference to a series of the Examples, though the present invention is in no way limited by these Examples.

In the following descriptions, ¹H-NMR analysis was conducted with ECP500, ex JEOL Ltd, using deuterated acetone as a determination solvent.

The purity of the silicone having an amino group at one terminal was determined by gas chromatography (GC) in the following manner.

Detector: flame ionization detector (FID), provided by Agilent Technologies.
Capillary column: HP-5MS having dimensions of 0.25 mm×30 m×0.25 μm, provided by J & W
A column temperature was raised to 50 degrees C. for 5 minutes, then, in a speed of 10 degrees C. per minute to 250 degrees C. and maintained at 250 degrees C.
Injection temperature: 250 degrees C.; temperature of FID: 300 degrees C.
Carrier gas: helium, 1.0 ml/minute
Split ratio: 50:1; injection volume: 1 μl

In Example 2, the GPC determination was conducted in order to determine whether the siloxane bond of the compound obtained was cut or not. The GPC analysis was conducted in the following conditions.

Measurement device: HLC-8220, provided by TOSOH Cop.

### [GPC Conditions]

Column Temperature: 40 degrees C.
Flow rate: 0.6 mL/min.
Mobile phase: tetrahydrofuran

### Columns:

### TSK gel Super H2500 (6.0×150)

### TSK gel Super HM-N (6.0×150)

Guard column TSK gel guardcolumn Super H-H (4.6×35)

Injection volume: 50 μl
Concentration of a sample: 0.3%
Detector: refractive index (RI)
In the following description, Bu is an abbreviation for a butyl group and Me is an abbreviation for a methyl group.

### Example 1

### Synthesis of Compound [II]-1

The starting material is represented by the following formula [I].

R′R₂SiO(R₂SiO)ₘR₂SiH [I]

To a two-litter flask equipped with a stirrer, a dimroth condenser, a thermometer and a dropping funnel added were 412 g (1 mol) of polysioxane having a hydrosilyl group at one terminal [I]-1 which is represented by the aforesaid general formula [I] wherein m is 3, R′ is a butyl group and R is a methyl group, and 412 g of dehydrated toluene and, then, heated to 80 degrees C. 4.0 Grams of a solution of complex catalyst of chloroplatinic acid neutralized with sodium bicarbonate and 1,1,3,3-tetramethyl-1,3-divinyldisiloxane in toluene, containing 0.5% of platinum, were added to the flask, subsequently 241 g (1.2 mols) of bis(trimethylsilyl)allylamine was added dropwise from a dropping funnel for 1 hour at a temperature of the contents in the flask of 80 to 90 degrees C. Then, the reaction mixture was maintained at 80 to 90 degrees C. for 2 hours. A sample of the reaction mixture was taken, to which an alkali was added to see if hydrogen gas generated. No hydrogen gas generated. This means that the polysioxane having a hydrosilyl group at one terminal did not remain in the reaction mixture. Toluene and the excessive amount of bis(trimethylsilyl)allylamine were evaporated at an internal temperature of 130 degrees C. and a reduced pressure to obtaine 603 g of a pale-yellow and transparent product.

The product obtained was analyzed by ¹H-NMR and was found to be a compound represented by the following formula [II]-1, having 0.98 mol with a yield of 98%.

BuMe₂SiO(Me₂SiO)₃Me₂SiC₃H₆N(SiMe₃)₂ [II]-1

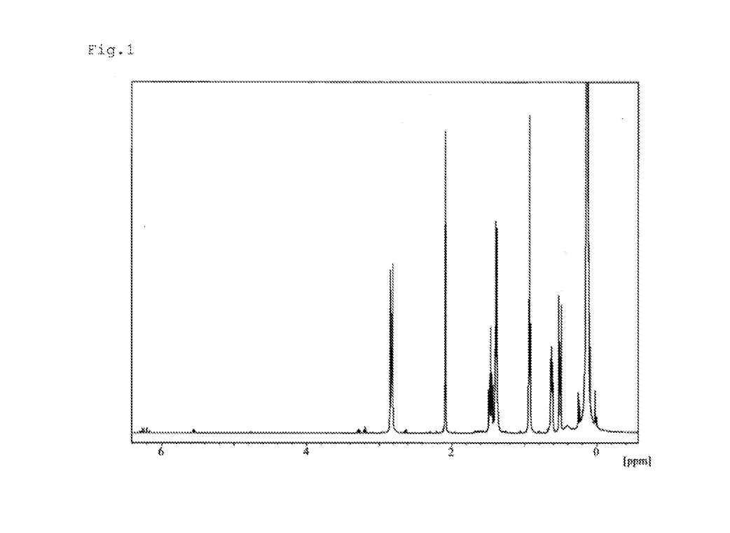

The purity of the compound represented by the formula [II]-1 determined by GC was 98.1%. The chart of ¹H-NMR is as shown in FIG. 1.

### Example 2

To a two-litter flask equipped with a stirrer, a dimroth condenser, a thermometer and a dropping funnel added were 482 g (0.2 mol) of polysioxane having a hydrosilyl group at one terminal [I]-2, which is represented by the aforesaid general formula [I] wherein m is 30, R′ is a butyl group and R is a methyl group, and 482 g of dehydrated toluene and then heated to 80 degrees C. 2.0 Grams of a solution of complex catalyst of chloroplatinic acid neutralized with sodium bicarbonate and 1,1,3,3-tetramethyl-1,3-divinyldisiloxane in toluene, containing 0.5% of platinum, were added to the flask, subsequently 48.2 g (0.24 mol) of bis(trimethylsilyl)allylamine was added dropwise from a dropping funnel for 1 hour at a temperature of the contents in the flask of 80 to 90 degrees C. Then, the reaction mixture was maintained at 80 to 90 degrees C. for 2 hours. A sample of the reaction mixture was taken, to which an alkali was added to see if hydrogen gas generated. No hydrogen gas generated. This means that the polysioxane having a hydrosilyl group at one terminal did not remain in the reaction mixture. Toluene and the excessive amount of bis(trimethylsilyl)allylamine were evaporated at an internal temperature of 130 degrees C. and a reduced pressure to obtaine 470 g of a pale-yellow and transparent product.

The product obtained was analyzed by ¹H-NMR and was found to be a compound represented by the following formula [II]-2, having 0.18 mol with a yield of 90%.

BuMe₂SiO(Me₂SiO)₃₀Me₂SiC₃H₆N(SiMe₃)₂ [II]-2

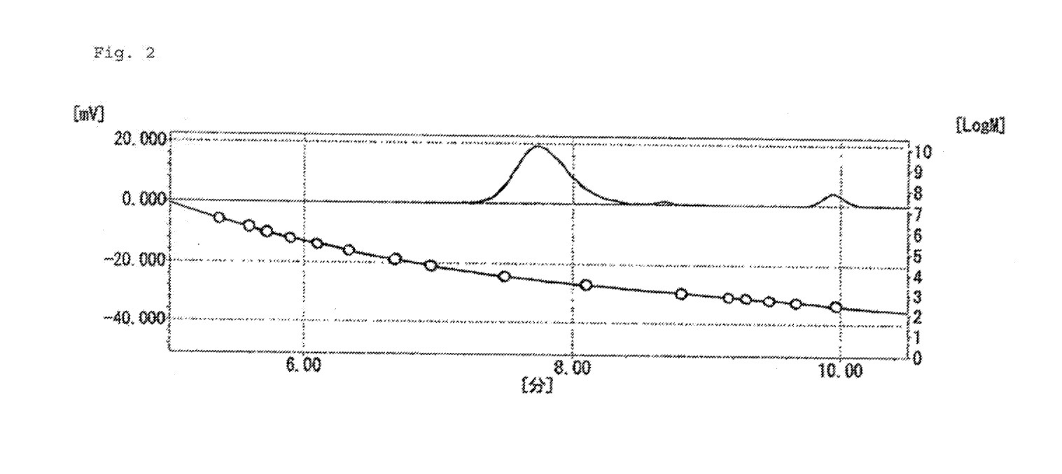

The GPC data is as shown in FIG. 2. As shown in this data, the siloxane bonds of the compound obtained were not cut.

### INDUSTRIAL APPLICABILITY

The present invention provides the novel silicone having an amino group at one terminal. The compound is usable in the preparation of the silicone having an amino group at one terminal by reacting the compound with (meth) acryloyl chloride.

1. A silicone having a bis(trialkylsilyl)aminopropyl group at one terminal and represented by the following general formula [II]:
R′R₂SiO(R₂SiO)ₘR₂SiC₃H₆N(SiR₃)₂ [II]
wherein m is an integer of from 1 to 200, R′ is an alkyl group having 1 to 4 carbon atoms, and R is an alkyl group having 1 to 10 carbon atoms.

2. The silicone according to claim 1, wherein m is an integer of from 2 to 80, R′ is selected from the group consisting of a methyl group, an ethyl group, a propyl group and a butyl group, and R is selected from the group consisting of a methyl group, an ethyl group, a propyl group, a butyl group and a pentyl group.

3. A method for preparing a silicone having a bis(trialkylsilyl)aminopropyl group at one terminal and represented by the following general formula [II]:
R′R₂SiO(R₂SiO)ₘR₂SiC₃H₆N(SiR₃)₂ [II]
wherein m is an integer of from 1 to 200, R′ is an alkyl group having 1 to 4 carbon atoms, and R is an alkyl group having 1 to 10 carbon atoms,
comprising a step of addition reacting a polysiloxane having a hydrosilyl group at one terminal and represented by the following general formula [I]:
R′R₂SiO(R₂SiO)ₘR₂SiH [I]
wherein m, R′ and R are as defined above,
with bis(tri C_{1 to 10} alkylsilyl)allylamine to thereby prepare said silicone having a bis(trialkylsilyl)aminopropyl group at one terminal.

4. The method according to claim 3, wherein m is an integer of from 2 to 80, R′ is selected from the group consisting of a methyl group, an ethyl group, a propyl group and a butyl group, and R is selected from the group consisting of a methyl group, an ethyl group, a propyl group, a butyl group and a pentyl group.
